(19) United States
(12) Patent Application Publication
(10) Pub. No.: US 2025/0259290 A1
(43) Pub. Date: Aug. 14, 2025

(54) SYSTEMS AND METHODS FOR POST-REPAIR INSPECTION OF A WORKSURFACE

(71) Applicant: 3M INNOVATIVE PROPERTIES COMPANY, St. Paul, MN (US)

(72) Inventors: Steven P. Floeder, Shoreview, MN (US); Alireza Ghaderi, Woodbury, MN (US); Jeffrey P. Adolf, Rochester, MN (US); Jonathan B. Arthur, Hudson, WI (US)

(21) Appl. No.: 18/856,804

(22) PCT Filed: Apr. 13, 2023
(86) PCT No.: PCT/IB2023/053800

§ 371 Date: Oct. 14, 2024

Related U.S. Application Data
(60) Provisional application No. 63/363,056, filed on Apr. 15, 2022.

(51) Int. Cl. G06T 7/00; B25J 11/00; G01N 21/88; G06T 7/579; H04N 23/56; H04N 23/695

(52) U.S. Cl. CPC G06T 7/0004; B25J 11/0065; G01N 21/8806; G06T 7/579; H04N 23/56; H04N 23/695; G01N 2021/8822

(57) ABSTRACT

A method of repairing a defect on a surface is presented that includes imaging the surface to locate the defect with a first imaging system. The method also includes conducting a repair operation by contacting the surface with an abrasive article. The abrasive article is pressed into contact with the surface in an area of the defect by a robotic repair system. The method also includes imaging the abraded surface, with a second imaging system. Imaging includes scanning the surface in the defect area to obtain a topography of the defect area, passing the second imaging system over the defect area such that a distance between the second imaging system and the surface is maintained. Imaging also includes generating an image of the defect area, wherein the image is a near dark field image or a dark field image and generating an evaluating regarding the repair operation based on the generated image.

### BACKGROUND

Clear coat repair is one of the last operations to be automated in the automotive original equipment manufacturing (OEM) sector. Techniques are desired for automating this process as well as other surface processing applications, including paint applications (e.g., primer sanding, clear coat defect removal, clear coat polishing, etc.), adhesive dispensing, film wrapping applications, or material removal systems are amenable to the use of abrasives and/or robotic inspection and repair. Defect repair presents many challenges for automation.

### SUMMARY

A method of repairing a defect on a surface is presented that includes imaging the surface to locate the defect with a first imaging system. The method also includes conducting a repair operation by contacting the surface with an abrasive article. The abrasive article is pressed into contact with the surface in an area of the defect by a robotic repair system. The method also includes imaging the abraded surface, with a second imaging system. Imaging includes scanning the surface in the defect area to obtain a topography of the defect area, passing the second imaging system over the defect area such that a distance between the second imaging system and the surface is maintained. Imaging also includes generating an image of the defect area, wherein the image is a near dark field image or a dark field image and generating an evaluating regarding the repair operation based on the generated image.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a schematic of a robotic surface processing system in which embodiments of the present invention are useful.

FIGS. 2A-2C illustrate defects that may be introduced during the clear coat repair process.

FIGS. 3A-3G illustrate operation of a line-scan array imaging system.

FIGS. 4A-4C-2 illustrate a process for detecting haze on a repaired surface.

FIGS. 5A-5B illustrate a line-scan array imaging system for a curved surface.

FIG. 6 illustrates an imaging system in accordance with embodiments herein.

FIG. 7 illustrates a surface imaging system in accordance with embodiments herein.

FIG. 8 illustrates a method of evaluating a defect repair in accordance with embodiments herein.

FIG. 9 is a defect inspection system architecture.

FIGS. 10-12 show examples of computing devices that can be used in embodiments shown in previous Figures.

FIGS. 13A-15B illustrate examples of surface processing and related calculations.

### DETAILED DESCRIPTION

Recent advancements in imaging technology and computational systems has made feasible the process of clear coat inspection at production speeds. In particular, stereo deflectometry has recently been shown to be capable of providing images and locations of paint and clear coat defects at appropriate resolution with spatial information (providing coordinate location information and defect classification) to allow subsequent automated spot repair. As automated imaging of worksurfaces improves, it is equally desired to improve the ability to automatically process worksurfaces. For example, in the case of clear coat repair, it is desired to repair detected defects, using a robotic repair system, with as little manual intervention as possible. However, as discussed herein, a worksurface exhibiting a high degree of curvature (one that deviates significantly from being a flat surface) is particularly challenging to process with a robotic system. Additionally, the presence of sharp surface features (tight bends, grooves, etc.) near the desired repair region can further complicate efforts to perform an automated repair. Similarly, curvature makes it difficult to obtain high fidelity images of a repair area after a repair operation. It is important to customers for a repaired surface to be quantifiable with respect to defect removal and introduction of new defects. However, while initial imaging of a vehicle is sufficient for locating defects for repair, a more detailed understanding of the vehicle surface, and its physical location with respect to an imaging system is needed to obtain high fidelity images of the repaired surface for quantitative repair evaluation.

As used herein, the term “vehicle” is intended to cover a broad range of mobile structures that receive at least one coat of paint or clear coat during manufacturing. While many examples herein concern automobiles, it is expressly contemplated that methods and systems described herein are also applicable to trucks, trains, boats (with or without motors), airplanes, helicopters, etc. Additionally, while vehicles are described as examples where embodiments herein are particularly useful, it is expressly contemplated that some systems and methods herein may apply to surface processing in other industries, such as painting, adhesive processing, or material removal, such as sanding or polishing wood, plastic, paint, etc.

The term “paint” is used herein to refer broadly to any of the various layers of e-coat, filler, primer, paint, clear coat, etc. of the vehicle that have been applied in the finishing process. Additionally, the term “paint repair” involves locating and repairing any visual artifacts (defects) on or within any of the paint layers. In some embodiments, systems and methods described herein use clear coat as the target paint repair layer. However, the systems and methods presented apply to any particular paint layer (e-coat, filler, primer, paint, clear coat, etc.) with little to no modification

As used herein, the term “defect” refers to an area on a worksurface that interrupts the visual aesthetic. For example, many vehicles appear shiny or metallic after painting is completed. A “defect” can include debris trapped within one or more of the various paint layers on the work surface. Defects can also include smudges in the paint, excess paint including smears or dripping, as well as dents.

Paint repair is one of the last remaining steps in the vehicle manufacturing process that is still predominantly manual. Historically this is due to two main factors, lack of sufficient automated inspection and the difficulty of automating the repair process itself so that repairs are less noticeable to potential purchasers than human-repaired defects. One of the problems concerning robotic repairs currently is the ability to quantitatively evaluate defects post-repair. Because the human eye can see the texture change, surface haze and scratches introduced during a repair, it is important to find ways to automatically image and quantify a vehicle surface post repair, without needing a human to review the repair for quality.

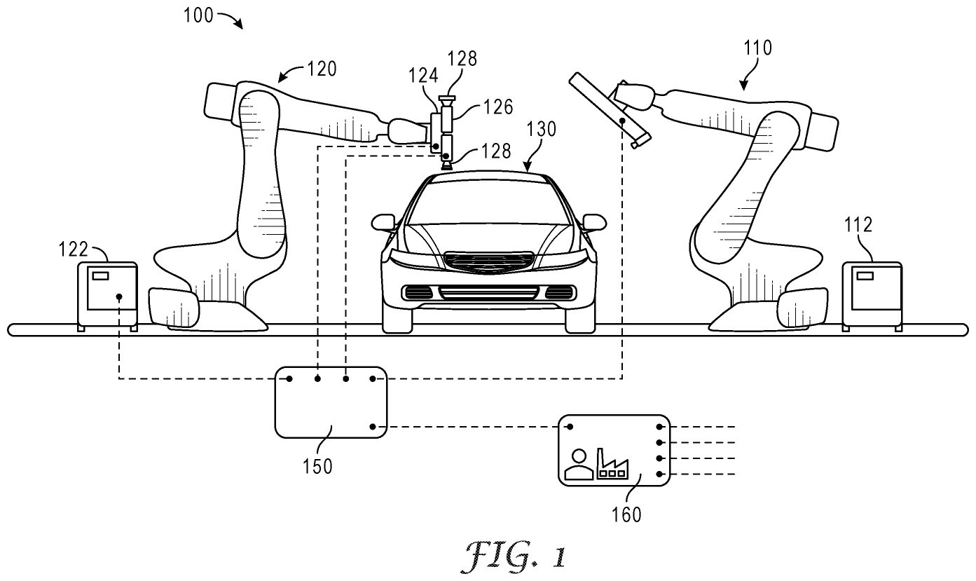

FIG. 1 is a schematic of a robotic paint repair system in which embodiments of the present invention are useful. System 100 generally includes two units, a visual inspection system 110 and a defect repair system 120. Both systems may be controlled by a motion controller 112, 122, respectively, which may receive instructions from one or more application controllers 150. The application controller may receive input, or provide output, to a user interface 160. Repair unit 120 includes a force control unit 124 that can be aligned with an end-effector 126. As illustrated in FIG. 1, end effector 126 includes two processing tools 128. However, other arrangements are also expressly contemplated.

The current state of the art in vehicle paint repair is to use fine abrasive and/or polish systems to manually sand/polish out the defects, with or without the aid of a power tool, while maintaining the desirable finish (e.g., matching specularity in the clear coat). An expert human executing such a repair leverages many hours of training while simultaneously utilizing their senses to monitor the progress of the repair and make changes accordingly. Such sophisticated behavior is hard to capture in a robotic solution with limited sensing.

Additionally, abrasive material removal is a pressure driven process while many industrial manipulators, in general, operate natively in the position tracking/control regime and are optimized with positional precision in mind. The result is extremely precise systems with extremely stiff error response curves (i.e., small positional displacements result in very large corrective forces) that are inherently bad at effort control (i.e., joint torque and/or Cartesian force)). Closed-loop force control approaches have been used (with limited utility) to address the latter along with more recent (and more successful) force controlled flanges that provide a soft (i.e., not stiff) displacement curve much more amenable to sensitive force/pressure-driven processing. The problem of robust process strategy/control, however, remains and is the focus of this work.

As described herein, post-repair inspection may take place substantially immediately after a repair, for example using an imaging system mounted in a tool position 128, opposite an abrasive repair tool in an opposing tool position 128. In other embodiments, post-repair inspection may be done by a second imaging system mounted on robotic unit 110, such that pre-repair and post-repair imaging are conducted by the same imaging system or, for example, one of a dual-mounted imaging system. In yet other embodiments, post-repair imaging is done by a third robotic system (not shown in FIG. 1).

Additionally, while systems and methods herein are discussed in a post-repair context, it is expressly contemplated that they could also be used in a pre-inspection context, for example to inform a defect repair process. For example, a global inspection may be conducted on vehicle 130, by inspection system 110 or systems described herein, to identify defect locations and types. Then a second pass may be done, either by the same or different system, to obtain a different or higher resolution image of a defect, or more precise location information. The second pass may be used to provide additional feedback for a defect repair system 100, e.g. changing the polishing step from 3 seconds to 5 seconds. In other embodiments, the second pass, or a third pass, is done after a repair to confirm that a defect has been repaired, and to understand how the repair has changed the surface—orange peel removal, introduction of haze or scratches, etc.

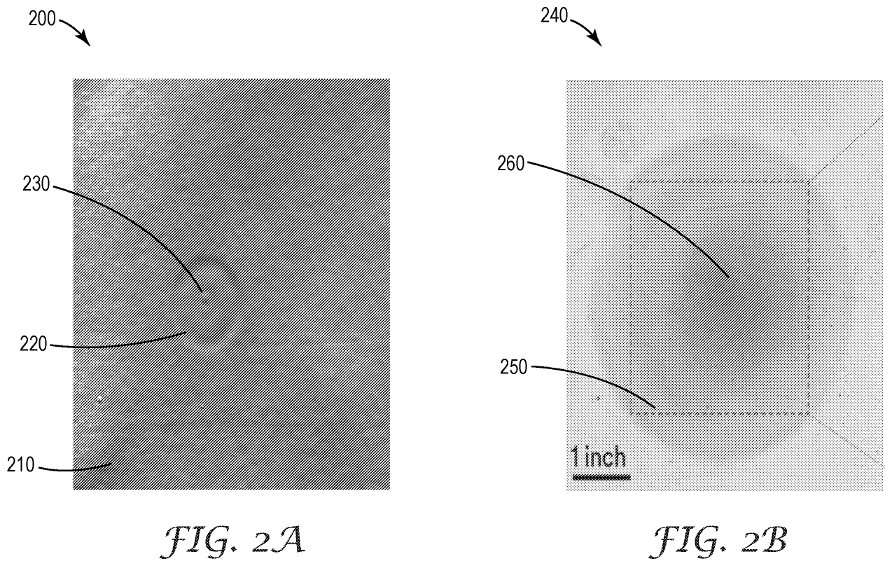

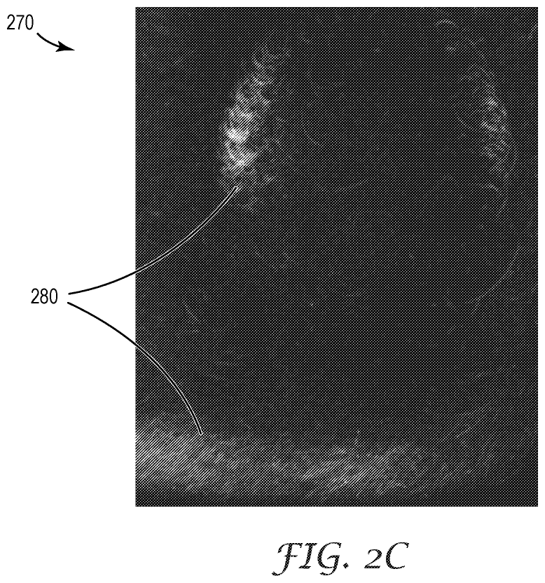

FIGS. 2A-2C illustrate defects that may be introduced during the clear coat repair process. FIGS. 2A-2C illustrate some examples of post-repair surfaces. Noncontact surface characterization of 3D objects requires characterization of surface properties independent of the object's shape, such as texture, smoothness and defects. Paint defects that form during painting process are often removed using abrasive media. However, the surface texture can be changed or ‘damaged’ during the abrasive process, which may change in the appearance of the repair area. Although the aim of the polishing process is to remove all sanding scratches and return the specular surface, micro scale scratches may be introduced that cause a haziness appearance on the surface.

It is important to understand how the surface changes because of an abrasive repair. Many solutions have been utilized over the years with deflectometry being most widely utilized, particularly in the automotive industry. Deflectometry has the advantages such as requiring only standard imaging equipment, being relatively tolerant of object curvature, and able to extract both high and low frequency image phenomena representing the object's surface. For detection of relatively severe defects over large surface areas, it has proven quite successful. However, deflectometry hasn't been successful for matte surfaces, more subtle surface defects or for characterizing other surface properties such as orange peel and haze. An imaging technique that is more sensitive is described herein that may enable more capable surface appearance measures for 3D objects.

FIG. 2A illustrates a post-repair image 200 of a surface. The surface has texture 210, referred to as “orange peel” because the consistency is similar to the surface of an orange fruit. A repair area 220 includes a repaired defect 230. Repairing a defect may not necessarily entail complete removal of the defect, in some instances, but may include grinding down the defect so that the surface is smooth, or otherwise altering the defect so that it is less visible. As illustrated in FIG. 2A, a clear perimeter of repair area 220 is visible, and may be visible to the human eye, which is undesirable. It is desired to repair a defect area 220 without a clear interruption of orange peel texture 210. One current tool for measuring orange peel is the WAVE-SCAN 3, from BYK Instruments. However, while current tools provide numerical results based on surface brilliance, they do not capture an image of the surface, or provide results based on a captured image. It has been found that different tools provide different numerical results, all based on the reflection of light from the surface. Additionally, many tools sample an area much smaller than the area of interest. For a spot repair by an original equipment manufacturer (OEM), it may be necessary to evaluate a 5 inch square area. Numerical results sampled from different points within the area will differ, and will not result in a holistic understanding of the surface texture.

FIG. 2B illustrates haze on a repaired surface 240. As illustrated in FIG. 2B, haze may not be consistent across a surface, for example higher in the center area 260 of a repair area than in an outer area 250. Because the haze is not consistent, a single point measurement, or even multiple point measurements, does not provide the same understanding of haze introduced in a surface during a repair as an image. The image of FIG. 2B can be obtained using embodiments herein in a dark-field image capturing mode of operation.

FIG. 2C illustrates a processed image of a repaired surface 270 that reveals scratches 280 introduced to a surface during the repair process. The image of FIG. 2C can be obtained using embodiments in a near-dark field image capturing mode of operation.

Described herein are systems and methods for holistically evaluating a repair on a surface. As described herein, a linescan camera array system may be preferred for imaging high reflective surfaces, such as vehicles with a clearcoat layer.

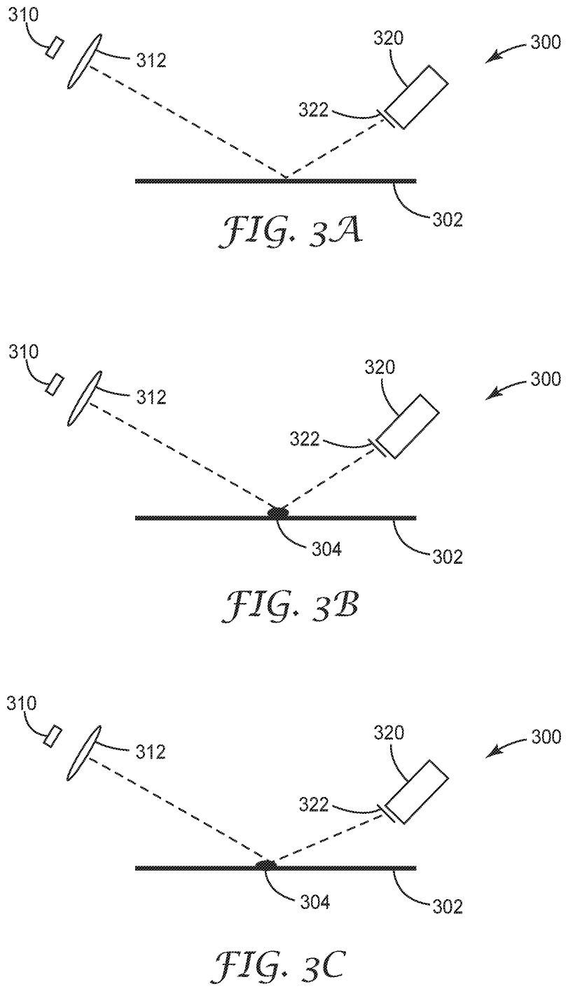

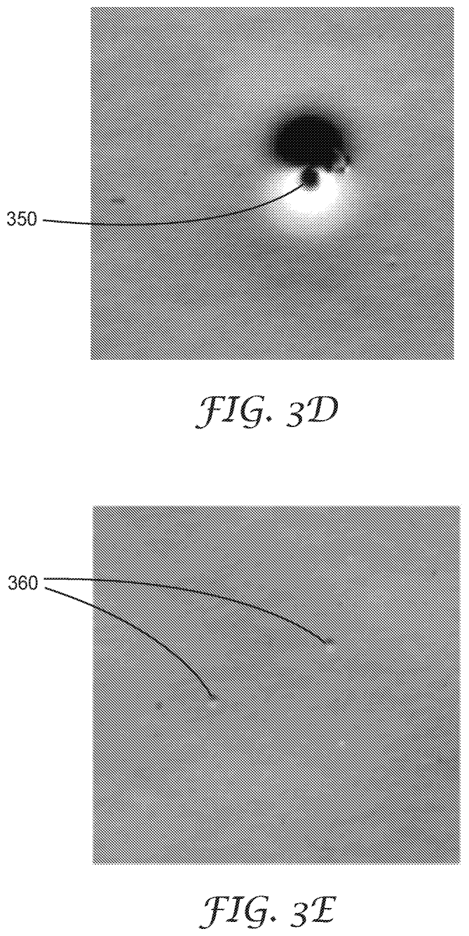

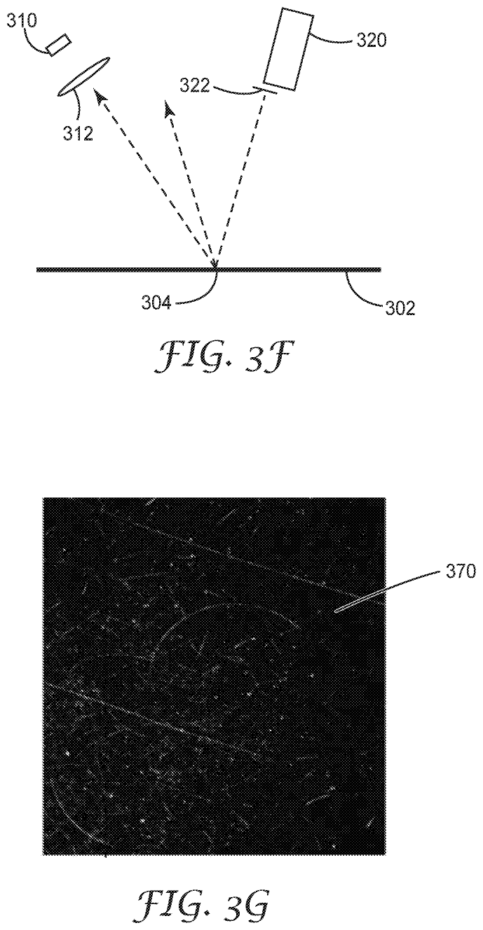

FIGS. 3A-3G illustrate operation of a line-scan array imaging system. FIG. 3A illustrates a linescan camera array system 300 with a linescan array 310, behind a lens 312. The array system is aimed at a surface 302 such that light from a light source 300 behind a knife edge 322, where everything is dark or gray. Array 310 captures a linear sequence of images that can be stitched together to form an image of a surface, as illustrated in FIGS. 3D and 3E. When linescan array 310 passes a defect, light is deflected differently. If anything on the surface scatters or deflects the reflected light, then the image appears darker (if deflecting into the knife) or lighter (if deflecting away from the knife). The images in FIGS. 3D-3E demonstrate this effect for a large defect 350 and for more subtle defects 360.

FIG. 3D illustrates a defect on a surface, as detected using a linescan array. The light portion illustrated in FIG. 3D is caused as the system moves over the defect on the surface. A linescan array, such as that illustrated in FIGS. 3A-3C is very sensitive to light deflection. A robotics system is useful for controlling a linescan array system because of the precise movement and control available using a robotic system.

In high reflective surfaces, such as clear coats, the angle of the light source and camera with respect to the sample are the key parameters for revealing surface attributes, similar to how humans observe surfaces at different angles to see different reflections of the surface. A linescan array, such as system 300, provides additional advantages, such as adjustable sensitivity by changing how close to the knife edge the imaging is aligned. A linescan array system also works for both specular and matte surfaces. Imaging systems that can quantify surface parameters such as defect removal, haze and scratches can help fine tune the automated defect removal process. It is desired to sand only as much as possible to remove a defect, polish enough to achieve the needed surface finish, and manage device settings such as force applied, dwell time and movement speed to reduce haze and scratches. Systems and methods herein provide helpful feedback for improved robotic control.

FIGS. 3A-3E illustrate one configuration of line scan array imaging system that might be useful for imaging defects and orange peel, in a dark field mode of imaging. In some embodiments, a different configuration is used in a near-dark field mode of imaging, as illustrated in FIG. 3F, where imaging device 320 and light source 310 are inclined close to the surface. While the angle of imaging device 320 and light source 310 may be fixed during a particular imaging pass over surface 302, it is expressly contemplated that a relative orientation between imaging device 320, surface 302 and light source 310 may change depending on images sought to be obtained. FIG. 3G illustrates a scratch image 370 that can be obtained in a near-dark field mode of imaging. Dark field imaging may be useful for detecting and characterizing paint defects and surface orange peel, while near-dark field imaging may be more useful for detecting haze and scratches on a surface.

In embodiments herein, it is envisioned that three passes may happen over a surface, first to obtain a rough idea of where a defect is located and an initial topography of the surface, a second in a dark-field mode, and a third in a near-dark field mode. However, it is possible that, in some embodiments as described herein, the first pass happens prior to a repair. Additionally, it is also contemplated that near-dark field imaging may happen prior to dark-field imaging.

Once images are captured using imaging device 320, different analysis techniques can be applied to better characterize and quantify defect information. For example, deflectometry can be used to detect quantitative height value information, while the line scan image array on its own can only provide qualitative data of a defect height. However, it is noted that line scan image array data seems to be consistent with human vision perception. Deflectometry is particularly useful with highly reflective images, such that sufficient fringe patterns can be generated.

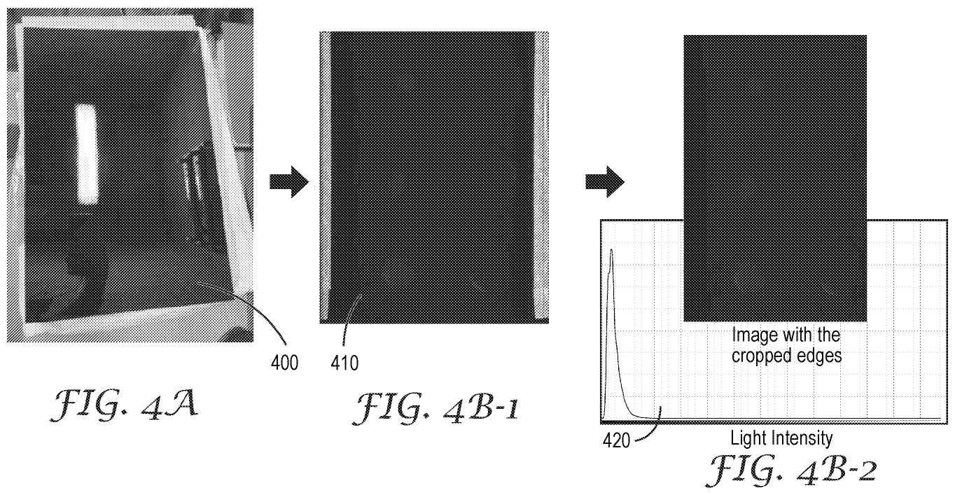

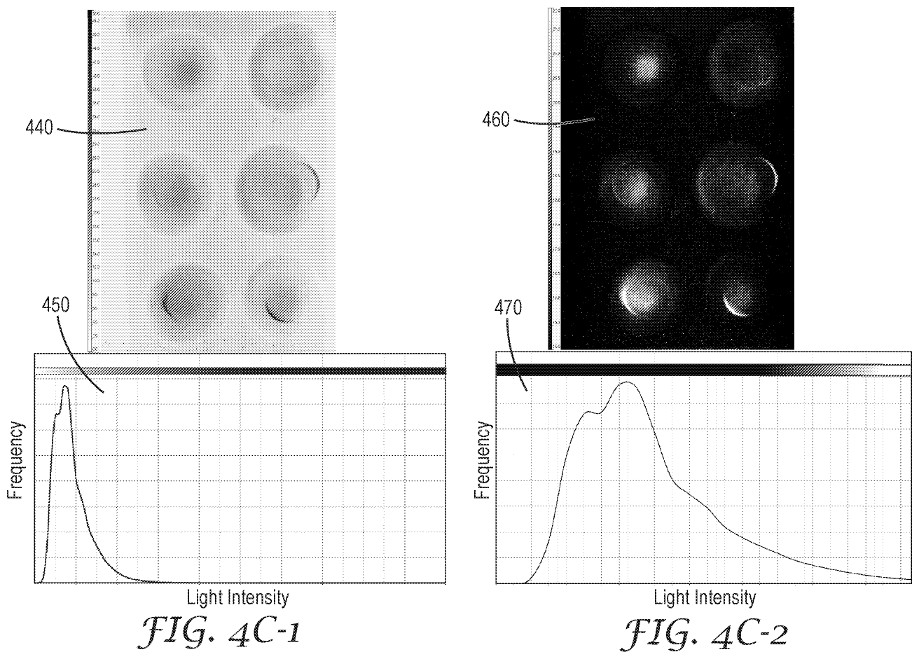

FIGS. 4A-4C illustrate a process for detecting haze and scratches on a repaired surface. FIG. 4A illustrates a 12-inch by 18-inch clear coat panel with six repaired spots. A raw image of the panel is captured by an imaging system, as illustrated in FIG. 4B-1. Illustrated in FIG. 4B-2 is a light intensity distribution of the image in FIG. 4B-1. The light intensity value for each pixel is based on the grayscale where 0 represents black and 255 represents white.

As illustrated in FIG. 4C-1, a haze image can be produced by inverting the grayscale values of all pixels followed by rescaling the pixels in such a way that 0 represents white and any values above 50 represent black, for example. The obtained image reveals the surface area of the panel that has been damaged due to the haze defect. Haze is more intensive in the region with darker color. In order to reveal the sand and buff scratches, the grayscale values of the raw image can be rescaled on a narrower grayscale range. This can be done, for example, as follows: any pixel with a value less than 15 needs to be converted to black while all the pixels with larger than 22 are changed to white. An example of such process is shown in FIG. 4C-2 for the image presented in FIG. 4B-1.

Previously, three separate devices were needed to characterize defect removal, haze and scratches. A line scan array imaging system as described herein, can provide images of the surface, understanding of surface texture, haze across an entire defect repair area, and scratches across an entire area with a single post-repair pass across the worksurface. Imaging a surface and, based on the imaging, providing an understanding all of these surface parameters at once, holistically across a repair area, has not been possible before.

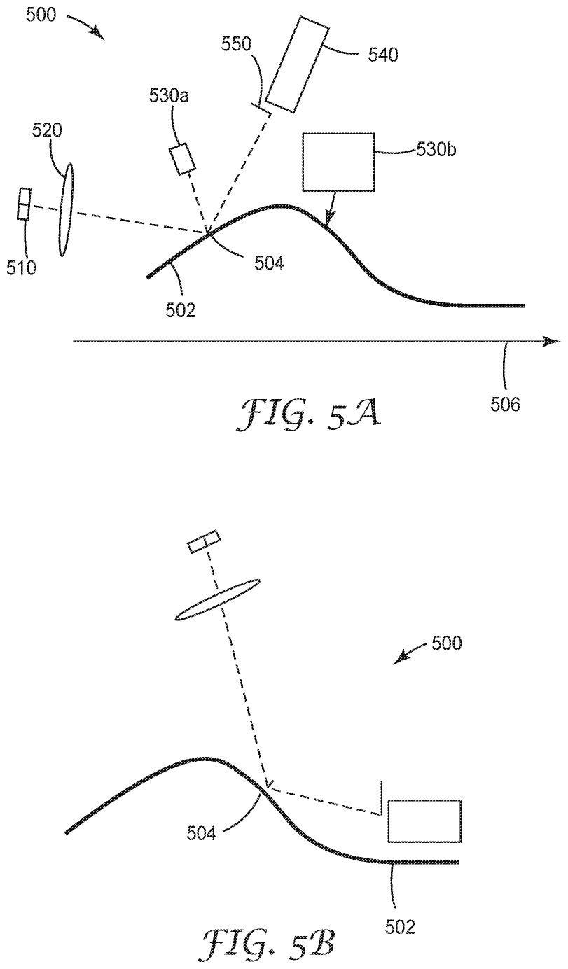

FIGS. 5A-5B illustrate a line-scan array imaging system for a curved surface. Unlike the flat surface illustrated in FIGS. 4A-4C, many vehicles have curved surfaces. However, for a linescan array to take high fidelity images, and for post-image processing and quantification, it is necessary to know have the sensing mechanism to be at a known position—both distance and angle, from the reflection point on the surface. While it may be possible to access a 3D model (e.g. a Computer-Aided Design or CAD model), such models may not be accurate enough, or may not be sufficient to know with sufficient precision where the reflection point is. It is desired to have a base understanding of the defect area, such as that obtained by imaging system 110, and then provide a linescan array with distance sensors to obtain a highly accurate topographical surface of the vehicle.

It is also necessary for the linescan array to be angled correctly with respect to the surface being imaged. It is desired that a right angle normal to the surface be present between the linescan array and the light source. In some embodiments herein, a distance sensor first passes over the worksurface, to obtain accurate distance and curvature information, followed by the linescan array in a second pass. In the second pass, the linescan array may be moved in order to achieve the desired position of a right angle normal to the surface at each point inspected. In other embodiments, the distance sensor is placed ahead of the linescan array. Based on feedback from the distance sensor, the linescan array position with respect to the worksurface is adjusted in-situ.

FIG. 5A illustrates a schematic view of an imaging system 500 imaging a surface 502. A linescan array 510, behind a lens 520, faces a surface 502, with the right angle between array 510 and light source 540 being orthogonal to surface 502 at point 504 as array 150 captures images of surface 502.

Imaging system 500 also includes a distance sensor, or distance sensor array. As many vehicles have surfaces with curvature in more than one direction, it is important to have distance information for at least the distance that the length of array 510 will pass through. As described above, in some embodiments a distance sensor travels separately from system 500, for example as illustrated by sensor position 530b. In some embodiments, sensor position 530b is representative of a real-time position of a sensor with respect to system 500 such that a sensor array moves, as indicated by arrow 506, across surface 502 ahead of system 500. Sensor position 530b illustrates an embodiment where a sensor array moves independently from system 500. However, it is expressly contemplated that a sensor array may be mechanically coupled In some embodiments, however, sensor position 530b is indicative of movement of the sensor array during a first pass, prior to system 500 traversing along path 506.

In some embodiments, a sensor array is mechanically coupled to system 500, as indicated by sensor position 530a, such that the sensor array travels along path 506 in a fixed position with respect to system 500. The entire system 500, with a sensor array in position 530a, may move across surface 502 in a first pass, so that distance sensors may capture accurate topography for surface 502, and then in a second pass so that system 500 may capture images of surface 502.

As illustrated in the transition from FIG. 5A to 5B, an orientation of system 500 changes in order to maintain a right angle at a normal to the point 504 being imaged. Based on information from a position sensor array, a robot arm, or other movement mechanism for system 500, rotates and moves system 500 to maintain a desired distance from, and orientation with respect to, surface 502. One sensor array is needed for a surface with zero Gaussian curvature, such as a cylindrical surface. However, multiple sensor arrays may be used in embodiments with non-zero Gaussian curvature surfaces, such as a spherical surface.

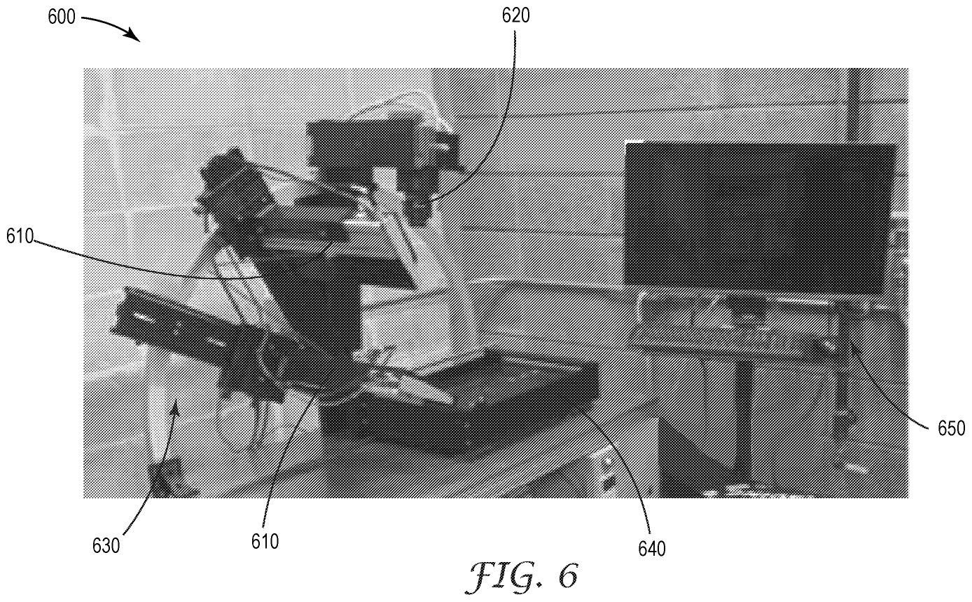

FIG. 6 illustrates an imaging system in accordance with embodiments herein. Imaging system 600 is controlled by a controller 650, which can receive instructions from an operator, for example using the illustrated keyboard. However, in some embodiments, system 600 is automatically controlled by controller 650, for example based on information received from a distance/position sensor or another source.

A linescan array 620 images a surface 640 which, in some embodiments, moves with respect to system 600. However, it is expressly contemplated that, in some embodiments, a worksurface remains stationary and system 600 is mobile. Light sources 610 is directed toward surface 640, so that light is reflected toward linescan array 620.

An orientation component 630, illustrated as a curved rail, may be used to maintain a desired orientation between light sources 610 and linescan array 620, while changing an orientation of system 600 with respect to a worksurface 640. This may be helpful in embodiments where surface 640 has curvature, to maintain a desired orientation of normal to a right angle formed by one of lights 610 and linescan array 620. In the illustrated embodiment, orientation component 630 operates independently to change the angle of light sources 610 and imaging device 620 with respect to surface 640. This may be preferred as the optimum arrangement to reveal and characterize a defect may differ based on the optical properties of the surface as well as the light incident angle and camera position.

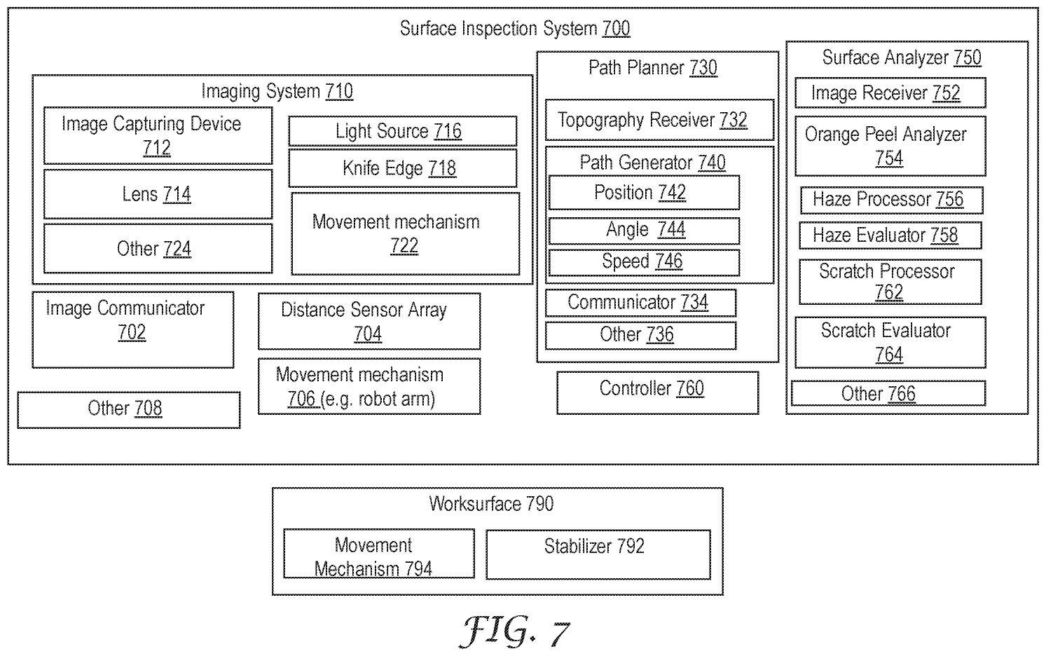

FIG. 7 illustrates a surface imaging system in accordance with embodiments herein. A surface imaging system 700 may be used to capture images of a worksurface 790. Worksurface 790 may be a vehicle, for example. Worksurface 790 may have curvature in one or more directions. Surface inspection system 700 may be useful for post-image repair, for example.

Surface inspection system 700 includes an imaging system 710 that captures images of worksurface 790. Images are captured by a linescan array 712. A lens 714 may be used to focus the cameras in the linescan array 712. Linescan array 712 is aimed at worksurface 790 such that light, from a light source 716 reflects off worksurface 790 to linescan array 712. A knife edge 718 is placed in front of light source 716. Imaging system 710 may include other features as well, such as a second lens 714, or a second light source 716. Imaging system 710 includes a movement mechanism, in some embodiments, such that imaging system 710 can move with respect to a worksurface 790 so that a normal is maintained with respect to the right angle formed by linescan array 712, worksurface 790, and light source 716. Movement mechanism 722 may rotate imaging system 710, raise or lower imaging system 710 with respect to worksurface 790, or otherwise adjust a relative position of imaging system 710 with respect to worksurface 790. Movement mechanism 722 may be part of, or coupled to, a robotic arm, in some embodiments. Imaging system 710 may capture images of worksurface 790, which may then be stored or processed, for example by surface analyzer 750.

Surface inspection system 700 includes a distance sensor 704, which may be a distance sensor array in some embodiments. Distance sensor array 704 may be coupled to imaging system 710, such that it moves with imaging system 710, in some embodiments. Imaging system may move ahead of imaging system 710, with imaging system 710 or behind imaging system 710. In other embodiments, distance sensor array 704 moves independently of imaging system 710. Distance sensor array 704 passes over worksurface 790, for example using movement mechanism 706, which may be coupled to, or separate from, movement mechanism 722. Distance sensor array 704 captures detailed topography information for worksurface 790 so that imaging system 710 can pass over worksurface 790 and take highly accurate images, from the desired orientation.

Distance information, captured from distance sensor array 704, is provided to path planner 730, which calculates a path for imaging system 710 to travel over worksurface 790. Topography receiver 732 receives distance information and provides topography information to path planner 730. Based on the worksurface topography, path generator 740 generates a path for imaging system 710 to travel. A path includes a position 742 of imaging system 710 relative to worksurface 790, ad an angle 744 that imaging system 710 needs to rotate in order to maintain a position normal to worksurface 790. Position 742 refers to a spatial position required to keep a desired distance between imaging system 710 and worksurface 790.

The imaging system is attached to a robot end effector. In addition, 3 or more distance sensors are included. Preferred sensors could be, for example, LM Series Precision Measurement Sensor from Banner Engineering, Keyence CL-3000 Series Confocal Displacement Sensor from Keyence.

The three or more sensors are spaced across the cameras effective field of view, to provide a sparse 3D distance map.

Many vehicles have defects to be repaired on surfaces that are curved in two directions. Therefore, using a standard line array, it may be that only a center section of the image will be valid. Suitable image processing can be done to identify valid regions, for example, using the image itself or using information from the 3D surface mapping. However, it is expressly contemplated that, in some embodiments, a 3D camera scanning system is used to fully map the surface. Such systems are available from companies such as Cognex, Keyence, and LMI.

From the 3D map, a path can be planned for the robot. The robot path is calculated so that at each point, the imaging system is normal to the surface. A robotic arm can precisely control angle and distance to ensure high quality imaging.

In some embodiments, path planner 730 is configured to allow for a single pass of imaging system 710 and distance sensor array 704 over worksurface 790. For example, topography receiver 732 can receive feedback from distance sensor array 704 substantially in real-time, and path generator 740 generates a path and provides instructions to movement mechanism 722 to change a position 742, angle 744 or speed 746 of imaging system 710 along a path. The distance sensor feedback is provided, path generated and communicated back to movement mechanism 722, using communicator 734, and imaging system 710 is moved accordingly in the time it takes for imaging system to traverse a distance between imaging system 710 and distance sensor array 704. For example, if distance sensor array 704 is coupled to imaging system 710 with a separation of 3 inches in between, then the information is transmitted, path returned, and imaging system adjusted in the time it takes for imaging system 710 to travel 3 inches.

In other embodiments, a two-pass system is used, such that, in a first pass, distance sensor array 704 retrieves topography information, which is provided to path planner 730, which generates and communicates, using communicator 734, the path back to movement mechanism 722, which implements the positions 742 and angles 744 for imaging system 710 during the second pass.

Path planner 730 may also have other features 736.

Images captured by imaging system 710 are provided to surface analyzer 750 which, in some embodiments, provides analysis regarding surface parameters of worksurface 790, such as whether a defect was sufficiently repaired, whether haze was introduced, or whether scratches were introduced. Images are received by image receiver 752. Image information may be received in substantially real-time from linescan array 712, in some embodiments, and image receiver 752 may assemble an image from the array signals received. Once the images of worksurface 790 are collected, they can be viewed by a human operator, or automatically analyzed for quality control concerns.

An orange peel analyzer 754 may provide an indication of orange peel on worksurface 790 outside the defect repair area, and/or an indication of orange peel on worksurface 790 within a defect repair area.

A haze processor 756 may, based on images received by image receiver 752, provide an image of worksurface 790 that indicates haze across the defect repair area. Haze evaluator 758 may provide an indication of the amount of haze, the acceptability of haze, or an indication of haze consistency across the defect repair area.

A scratch processor 762 may, based on images received by image receiver 752, provide an image of worksurface 790 that indicates scratches introduced into worksurface 790 by the defect repair process. Scratch evaluator 764 may provide an indication of the amount, type, severity or position of scratches across the defect repair area.

Information from orange peel analyzer 754, haze evaluator 758 and scratch evaluator 764 may be provided, in some embodiments, to controller 760, which may adjust one or more repair parameters for the next operation to better retain orange peel, reduce haze and reduce scratches. Controller 760 may also provide control signals to components of surface inspection system 700, for example for movement mechanism 722 to adjust a position or angle of imaging system 710, for imaging system 710 to begin capturing an image, or for distance sensors to begin capturing topography information.

Systems and methods have been described herein for scenarios where a worksurface is stationary during topography or imaging collection. However, it is expressly contemplated that systems and methods herein may also be applicable to embodiments where worksurface 790 is moving. Imaging system 710 may also be moving, either in the same or different direction of worksurface 790, or imaging system 710 may be stationary. In such embodiments where worksurface 790 is mobile, it may have a movement mechanism 794, such as a conveyor belt or wheels, and may also have one or more stabilizers 792 to keep worksurface 790 stable during imaging.

In some embodiments, a custom imaging lens includes telecentric imaging with a compact design is used to improve operation.

In some embodiments, the light source is a diffuse LED light with a knife edge. In another embodiment, the light source includes a small LCD display with individually addressable pixels, which may allow for sensitivity to be changed with no mechanical adjustments. In some embodiments, the knife edge has a automated height adjustment mechanism.

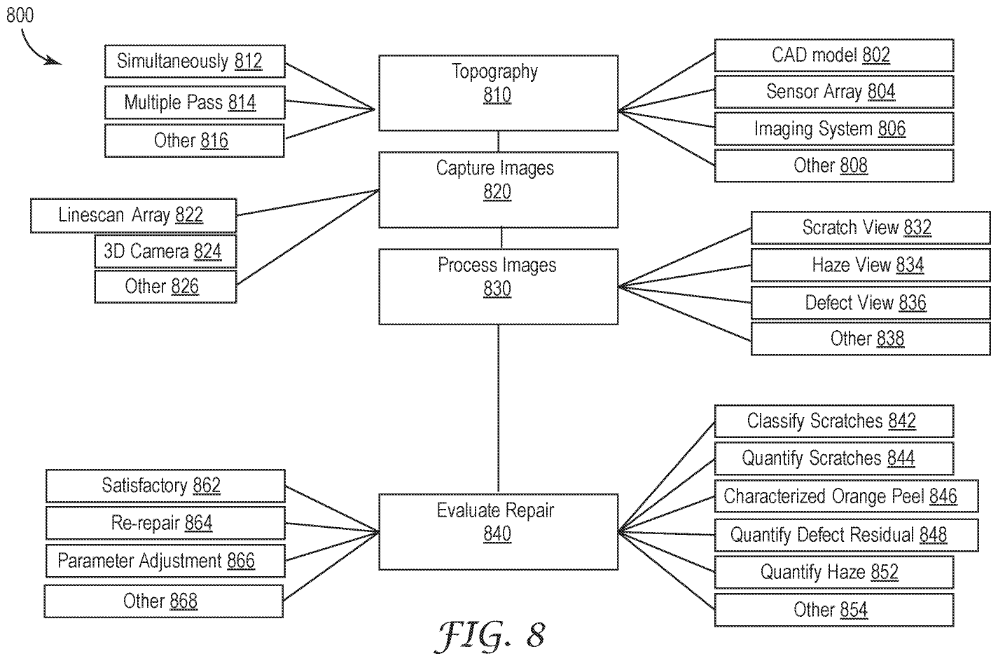

FIG. 8 illustrates a method of evaluating a defect repair in accordance with embodiments herein. Method 800 may be used with any systems described herein, or another suitable system that images and analyzes images of a worksurface.

In block 810, a topography of a worksurface is obtained. In some embodiments, this includes retrieving a 3D model, such as a CAD model 802. However, a CAD model 802 is often not completely accurate with respect to surface topography, as paint coating can be uneven and a vehicle may not be perfectly oriented or positioned in space. Therefore, in order to get high quality images of the surface, it is necessary, in some embodiments, to use a sensor array 804 to get an accurate topography of the surface, particularly as many surfaces have curvature in multiple directions. For example, many vehicles have surfaces that curve in at least two directions. In another embodiment, it may be possible to obtain an accurate topography using an imaging system 806, for example using an imaging system that also detects defects on the surface. Other suitable systems 808 may be sued to obtain a surface topography.

In block 820, images are captured. Images can be captured using a linescan array 822 at a known distance from the surface, in some embodiments. In some embodiments a 3D camera 824 is used. For curved surfaces, it is necessary for an imaging device to be at a known distance from the surface at all times during a scan. Therefore, in some embodiments capturing images, in block 820, includes an imaging device traveling along a path such that a set distance and/or orientation is maintained with respect to the surface being imaged. Other suitable imaging devices may be used, as indicated in block 826.

In block 830, captured images are processed to obtain information about the surface. As described herein, from images captured of a surface, a scratch view 832 may be generated that highlights scratches created on a surface during a defect removal operation. Additionally, a haze view 834 may be generated that illustrates what haze was introduced into a defect repair area. The original photos captured may also be used to understand whether a defect was successfully removed, as indicated in block 836. Other processing may be done to generate other useful views, as indicated in block 838.

In block 840, a defect repair is evaluated. Evaluating a defect may be done manually, for example providing images generated in block 830 to a human operator who indicates whether the repair is satisfactory 862, whether another repair operation has to be done, as indicated in block 864 and/or whether a parameter needs to be adjusted in a robotic repair unit for future repairs, e.g. lower or higher force, dwell time, speed, etc., as indicated in block 868.

Alternatively, or additionally, the repair may be evaluated quantitatively by an image analyzer. Scratches may be classified, as indicated in block 842, for example as introduced by sanding or polishing, or based on depth. Scratches may be quantified, as indicated block 844, either by number, location or another metric. Orange peel may be characterized, as indicated in block 846, for example based on a maximum difference in orange peel in the repair area and the area surrounding the repair area, or based on a variance in orange peel within the defect area, or another characteristic. A defect residual may also be quantified, as indicated in block 848. For example, in the case of a particulate trapped under a clearcoat layer, it may not be necessary to remove the entire particulate, but only to smooth the surface. Therefore, whether the defect was sufficiently removed may be quantified in block 848. Haze may also be quantified, as indicated in block 852, for example a maximum haze within a repair area, a haze variance within the repair area, a range of haze values present within the repair area, or another suitable parameter. Other characteristics may also be quantified, as indicated in block 854.

In some embodiments, at least some of the steps in method 800 are completed automatically. For example, in a two-pass system, a second imaging pass may begin automatically after topography is obtained and a path planned for the imaging system. Additionally, processing of images may be done as soon as they are received, or even in-situ as imaging data is received, from a linescan array system. The repair may also be evaluated once images are processed. Instructions for components to conduct each of the steps or analyses illustrated in FIG. 8 may be provided by a robot controller, such as application controller 150 in FIG. 1, for example. The instructions may include movement instructions for different components, including direction, speed, orientation, etc.

Method 800 may need to be executed multiple times during a repair. For example a typical repair includes (1) defect location and pre-inspection, (2) sanding, (3) wiping, (4) polishing, (5) wiping and (6) final inspection. Imaging may be needed in steps (1) and (6) and, based on imaging in (1), a sanding recipe may be selected to address a particular defect. After wiping step (3), the defect area may again be imaged so that a defect residual may be detected, characterized and quantified to determine whether steps (2) and (3) need to be repeated with the same or different sanding recipe, as well as to select a polishing recipe. After polishing, the defect area may again be imaged to evaluate haze or scratching. Based on haze or scratch imagery, the overall repair may be characterized as a success or failure. Images captured at any point during the process may be stored in a data store for later retrieval, human inspection, or as the basis for machine learning for improved sanding recipe and polishing recipe generation and selection. Alternatively, imaging may only be done post polishing, such that sanding and polishing are both done before the imaging is done.

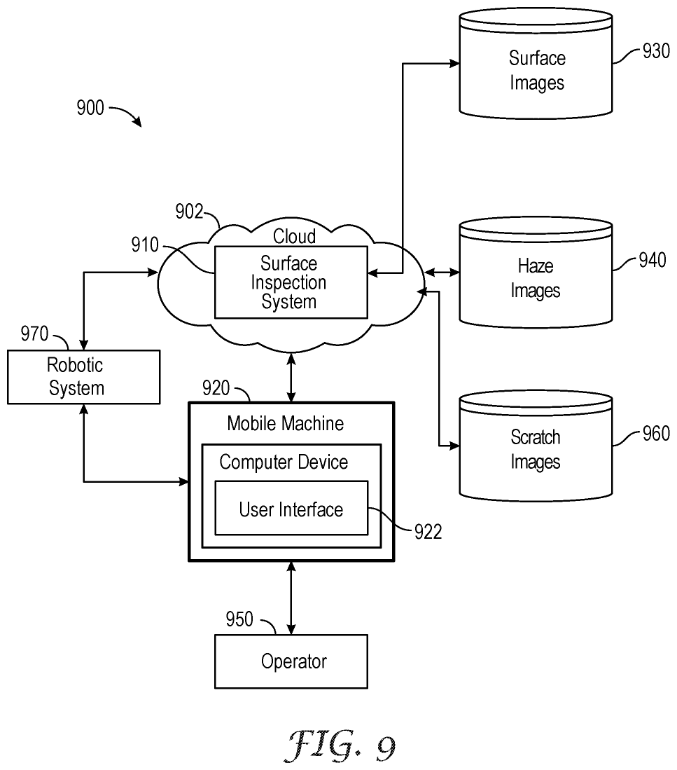

FIG. 9 is a surface process system architecture. The surface processing system architecture 900 illustrates one embodiment of an implementation of a surface inspection system 910. As an example, surface process system 800 can provide computation, software, data access, and storage services that do not require end-user knowledge of the physical location or configuration of the system that delivers the services. In various embodiments, remote servers can deliver the services over a wide area network, such as the internet, using appropriate protocols. For instance, remote servers can deliver applications over a wide area network and they can be accessed through a web browser or any other computing component. Software or components shown or described in FIGS. 1-8 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided by a conventional server, installed on client devices directly, or in other ways.

In the example shown in FIG. 8, some items are similar to those shown in earlier figures. FIG. 9 specifically shows that a surface inspection system 910 can be located at a remote server location 902. Therefore, computing device 920 accesses those systems through remote server location 902. Operator 950 can use computing device 920 to access user interfaces 922 as well.

FIG. 9 shows that it is also contemplated that some elements of systems described herein are disposed at remote server location 902 while others are not. By way of example, storage 930, 940 or 960 or robotic systems 970 can be disposed at a location separate from location 902 and accessed through the remote server at location 902. Regardless of where they are located, they can be accessed directly by computing device 920, through a network (either a wide area network or a local area network), hosted at a remote site by a service, provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers.

It will also be noted that the elements of systems described herein, or portions of them, can be disposed on a wide variety of different devices. Some of those devices include servers, desktop computers, laptop computers, imbedded computer, industrial controllers, tablet computers, or other mobile devices, such as palm top computers, cell phones, smart phones, multimedia players, personal digital assistants, etc.

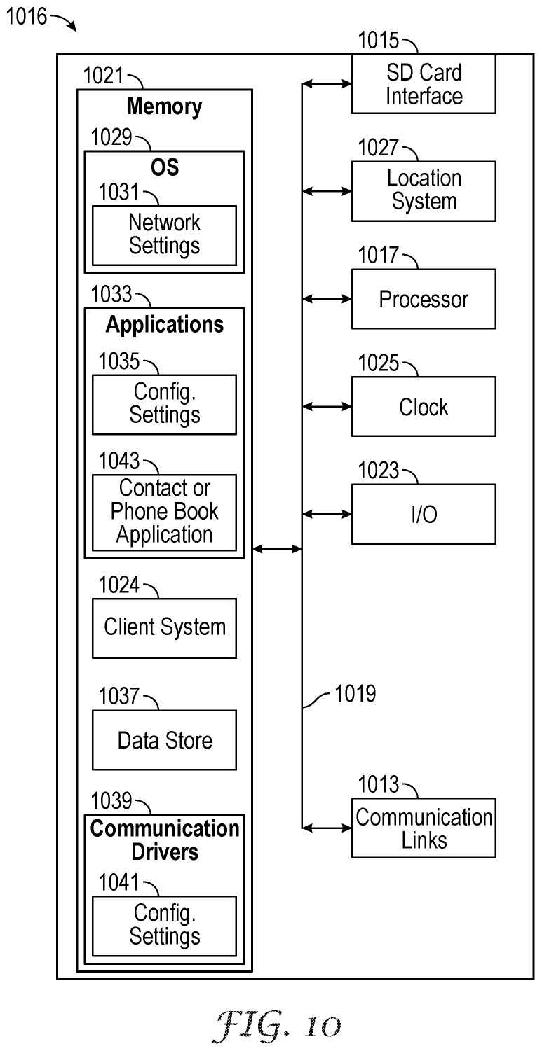

FIGS. 10-12 show examples of computing devices that can be used in embodiments shown in previous Figures.

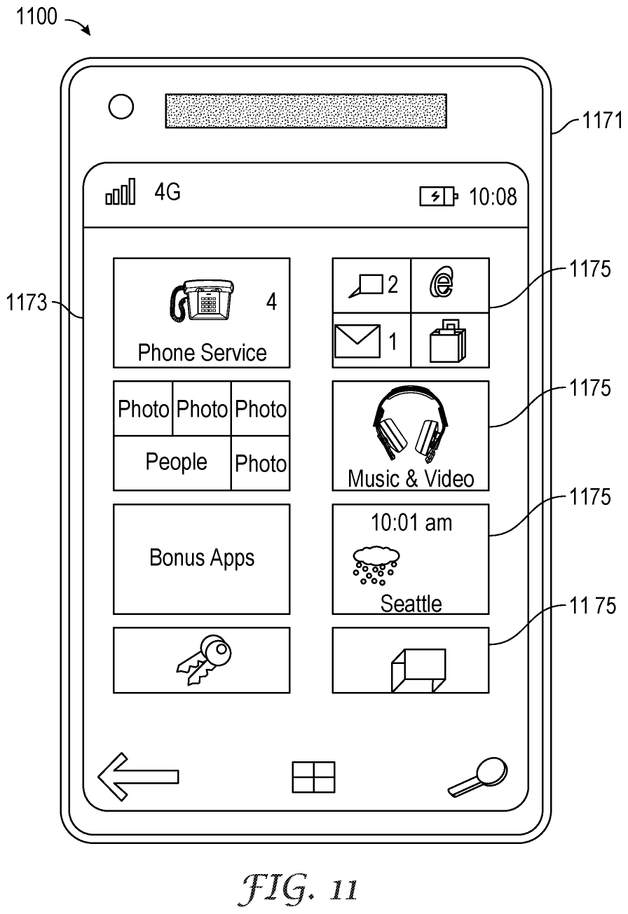

FIG. 10 is a simplified block diagram of one illustrative example of a handheld or mobile computing device that can be used as a user's or client's handheld device 16 (e.g., as computing device 920 in FIG. 9), in which the present system (or parts of it) can be deployed. For instance, a mobile device can be deployed in the operator compartment of computing device 920 for use in generating, processing, or displaying the data. FIG. 11 is another example of a handheld or mobile device.

FIG. 10 provides a general block diagram of the components of a client device 1016 that can run some components shown and described herein. Client device 1016 interacts with them, or runs some and interacts with some. In the device 916, a communications link 1013 is provided that allows the handheld device to communicate with other computing devices and under some embodiments provides a channel for receiving information automatically, such as by scanning. Examples of communications link 1013 include allowing communication though one or more communication protocols, such as wireless services used to provide cellular access to a network, as well as protocols that provide local wireless connections to networks.

In other examples, applications can be received on a removable Secure Digital (SD) card that is connected to an interface 1015. Interface 1015 and communication links 1013 communicate with a processor 1017 (which can also embody a processor) along a bus 1019 that is also connected to memory 1621 and input/output (I/O) components 923, as well as clock 1025 and location system 1027.

I/O components 1023, in one embodiment, are provided to facilitate input and output operations and the device 1016 can include input components such as buttons, touch sensors, optical sensors, microphones, touch screens, proximity sensors, accelerometers, orientation sensors and output components such as a display device, a speaker, and or a printer port. Other I/O components 1023 can be used as well.

Clock 1025 illustratively comprises a real time clock component that outputs a time and date. It can also provide timing functions for processor 1017.

Illustratively, location system 1027 includes a component that outputs a current geographical location of device 1016. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 1021 stores operating system 1029, network settings 1031, applications 1033, application configuration settings 1035, data store 1037, communication drivers 1039, and communication configuration settings 1041. Memory 1021 can include all types of tangible volatile and non-volatile computer-readable memory devices. It can also include computer storage media (described below). Memory 1021 stores computer readable instructions that, when executed by processor 1017, cause the processor to perform computer-implemented steps or functions according to the instructions. Processor 1017 can be activated by other components to facilitate their functionality as well.

FIG. 11 shows that the device can be a smart phone 1101. Smart phone 1171 has a touch sensitive display 1173 that displays icons or tiles or other user input mechanisms 1175. Mechanisms 1175 can be used by a user to run applications, make calls, perform data transfer operations, etc. In general, smart phone 1171 is built on a mobile operating system and offers more advanced computing capability and connectivity than a feature phone.

Note that other forms of the devices 1116 are possible.

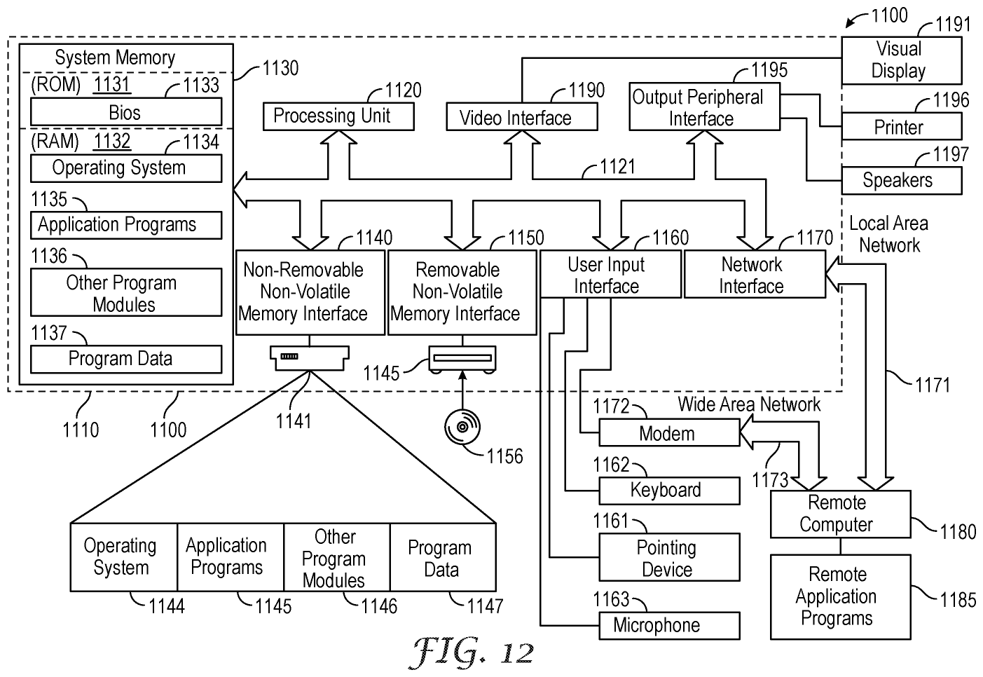

FIG. 12 is a block diagram of a computing environment that can be used in embodiments shown in previous Figures.

FIG. 12 is one example of a computing environment in which elements of systems and methods described herein, or parts of them (for example), can be deployed. With reference to FIG. 12, an example system for implementing some embodiments includes a general-purpose computing device in the form of a computer 1210. Components of computer 1210 may include, but are not limited to, a processing unit 1220 (which can comprise a processor), a system memory 1230, and a system bus 1221 that couples various system components including the system memory to the processing unit 1220. The system bus 1221 may be any of several types of bus structures including a memory bus or memory controller, a peripheral bus, and a local bus using any of a variety of bus architectures. Memory and programs described with respect to systems and methods described herein can be deployed in corresponding portions of FIG. 12.

Computer 1210 typically includes a variety of computer readable media. Computer readable media can be any available media that can be accessed by computer 1210 and includes both volatile/nonvolatile media and removable/non-removable media. By way of example, and not limitation, computer readable media may comprise computer storage media and communication media. Computer storage media is different from, and does not include, a modulated data signal or carrier wave. It includes hardware storage media including both volatile/nonvolatile and removable/non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1230 includes computer storage media in the form of volatile and/or nonvolatile memory such as read only memory (ROM) 1231 and random access memory (RAM) 1232. A basic input/output system 1233 (BIOS) containing the basic routines that help to transfer information between elements within computer 1210, such as during start-up, is typically stored in ROM 1231. RAM 1232 typically contains data and/or program modules that are immediately accessible to and/or presently being operated on by processing unit 1220. By way of example, and not limitation, FIG. 12 illustrates operating system 1234, application programs 1235, other program modules 1236, and program data 1137.

The computer 1210 may also include other removable/non-removable and volatile/nonvolatile computer storage media. By way of example only, FIG. 12 illustrates a hard disk drive 1241 that reads from or writes to non-removable, nonvolatile magnetic media, nonvolatile magnetic disk 1252, an optical disk drive 1255, and nonvolatile optical disk 1256. The hard disk drive 1241 is typically connected to the system bus 1221 through a non-removable memory interface such as interface 1240, and optical disk drive 1255 are typically connected to the system bus 1221 by a removable memory interface, such as interface 1250.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 12, provide storage of computer readable instructions, data structures, program modules and other data for the computer 1210. In FIG. 12, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237.

A user may enter commands and information into the computer 1210 through input devices such as a keyboard 1262, a microphone 1263, and a pointing device 1261, such as a mouse, trackball or touch pad. Other input devices (not shown) may include a joystick, game pad, satellite receiver, scanner, or the like. These and other input devices are often connected to the processing unit 1220 through a user input interface 1260 that is coupled to the system bus, but may be connected by other interface and bus structures. A visual display 1291 or other type of display device is also connected to the system bus 1221 via an interface, such as a video interface 1290. In addition to the monitor, computers may also include other peripheral output devices such as speakers 1297 and printer 1296, which may be connected through an output peripheral interface 1295.

The computer 1210 is operated in a networked environment using logical connections, such as a Local Area Network (LAN) or Wide Area Network (WAN) to one or more remote computers, such as a remote computer 1280.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. In a networked environment, program modules may be stored in a remote memory storage device. FIG. 12 illustrates, for example, that remote application programs 1285 can reside on remote computer 1280.

A method of repairing a defect on a surface is presented. The method includes imaging the surface to locate the defect with a first imaging system. The method also includes conducting a repair operation by contacting the surface with an abrasive article. The abrasive article is pressed into contact with the surface in an area of the defect by a robotic repair system. The method also includes imaging the abraded surface, with a second imaging system. Imaging includes scanning the surface in the defect area to obtain a topography of the defect area. Imaging also includes passing the second imaging system over the defect area such that a distance between the second imaging system and the surface is maintained. Imaging also includes generating an image of the defect area. The image is a near dark field image or a dark field image. The method also includes generating an evaluation regarding the repair operation based on the generated image.

The method may be implemented such that the second imaging system includes a linescan array.

The method may be implemented such that the imaging system includes a light source. The imaging system operates in a near-dark field mode, with the light source and the linescan array in a first configuration with respect to the surface, and in a dark field mode, with the light source and the linescan array in a second configuration.

The method may be implemented such that the image is a near dark field image. The method further includes: passing the second imaging system over the defect area in a second pass such that a second distance between the second imaging system and the surface is maintained and generating a dark field image of the defect area.

The method may be implemented such that the second imaging system is positioned on a robotic arm of the robotic repair system.

The method may be implemented such that the second imaging system is positioned on a first robotic arm. The abrasive article is coupled to a second robotic arm.

The method may be implemented such that it includes displaying the generated image on a display component.

A surface evaluation system is presented that includes an image capturing system that captures an image of a surface. The image capturing system includes a light source, an image capturing device configured to capture a near dark field or dark field image of the surface, and a movement mechanism configured to move the image capturing device with respect to the curved surface. The movement mechanism maintains a fixed distance between the image capturing stance and the surface while the image capturing device moves with respect to the surface. The system also includes a view generator that, based on the near dark field or dark field image, generates a view of the surface.

The system may be implemented such that the generated view shows surface variations indicative of haze.

The system may be implemented such that the generated view shows surface variations indicative of discrete defects.

The system may be implemented such that the discrete defects are dents or similar surface variations.

The system may be implemented such that it includes a dent evaluator that provides a localized position of the dent and an indication of dent severity.

The system may be implemented such that the discrete defects are scratches.

The system may be implemented such that it includes a scratch evaluator that provides a localized position of the scratch and an indication of scratch severity.

The system may be implemented such that it includes a display configured to display the image, the haze view or the scratch view.

The system may be implemented such that it includes a storage component configured to store the image, the haze view and the scratch view.

The system may be implemented such that, based on the image, a haze view or a scratch view, a surface evaluator provides a pass indication or a fail indication.

The system may be implemented such that the surface evaluator provides the pass indication or the fail indication based on a comparison of the haze view to a haze threshold. The pass indication is provided if the haze view has a lower amount of haze than a haze threshold.

The system may be implemented such that the surface evaluator provides the pass indication or the fail indication based on a comparison of the scratch view to a scratch threshold. The pass indication is provided if the scratch view has a lower scratch indication than a scratch threshold. The scratch indication is a number of scratches, a depth of scratches, a location of scratches or a type of scratches.

The may be implemented such that the surface evaluator provides the pass indication or the fail indication based on a comparison of a detected defect residual to a residual threshold. The pass indication is provided if the defect residual is smaller than a residual threshold.

The system may be implemented such that it includes a path generator that receives topography information for the curved surface and, based on the topography information, generates a path for the movement mechanism that maintains a relative position of the image capturing device, the light source and the curved surface with respect to each other.

The system may be implemented such that the image capturing device, the surface and the light source form a right angle at a point on the surface being imaged.

The system may be implemented such that the topography information includes a topography generated based on sensor information from a distance sensor array.

The system may be implemented such that the distance sensor array is coupled to the movement mechanism, and moves ahead of the image capturing device, with respect to the curved surface. The path generator generates the path and provides the path to the movement mechanism in situ.

The system may be implemented such that the image capturing device is a linescan array.

The system may be implemented such that the image capturing device is a 3D camera.

The system may be implemented such that it includes a lens between the image capturing device and the light source.

The system may be implemented such that it includes a knife edge between the image capturing device and the light source.

The system may be implemented such that it includes the surface is a curved surface and maintaining the distance includes adjusting a position of the imaging system to follow a curvature of the curved surface.

The system may be implemented such that image is generated during a processing step.

The system may be implemented such that the image capturing device is a linescan array. The processing step includes stitching captured image data into the image.

A robotic surface inspection system is presented that includes a motive robotic arm and

an imaging system, coupled to the motive robotic arm, that captures an image of a surface. The imaging system includes a light source, a knife edge positioned in front of the light source, and an image capturing device positioned such that light from the light source passes in front of the knife edge, reflects off the surface to the image capturing device. A position of the light source and the image capturing device are fixed with respect to each other during an imaging operation. The system also includes a movement mechanism that moves the imaging system with respect to a surface during the imaging operation so that a fixed distance and orientation is maintained between the surface and the imaging system is maintained. The system also includes a surface topography system. The surface topography system includes a distance sensor array that moves with respect to the surface and a topography generator that generates a topography based on sensor signals from the distance sensor array. The system also includes a controller that generates movement commands to the motive robotic arm that maintains a relative position of the imaging system with respect to a surface being imaged as the imaging system and the surface are moved with respect to each other. The controller generates the movement commands based on the generated topography.

The system may be implemented such that the surface is stationary and the imaging system moves with respect to the surface.

The system may be implemented such that the imaging system is stationary. The surface moves with respect to the imaging system.

The system may be implemented such that the orientation includes a right angle formed between the image capturing device, the surface, and the light source.

The system may be implemented such that, in a first movement sequence, the distance sensor array captures topography information and in a second movement sequence, the imaging system captures image information.

The system may be implemented such that the surface topography system and the imaging system are both active during a movement sequence. The topography generator generates the topography in-situ. The controller generates the movement commands in-situ based on received topography information from the topography generator in substantially real-time.

The system may be implemented such that it includes a haze image generator that generates a haze image based on the image.

The system may be implemented such that it includes a haze evaluator that provides an indication of an amount of haze in the haze view.

The system may be implemented such that it includes a scratch image generator that generates a scratch image based on the image.

The system may be implemented such that it includes a scratch evaluator that provides a scratch indication based on the scratch view.

The system may be implemented such that the scratch indication is a number of scratches, a location of scratches, a depth of scratches, or a type of scratches.

The system may be implemented such that it includes a defect residual detector that detects a defect residual in the image.

The system may be implemented such that it includes a defect residual evaluator that is configured to provide a defect residual indication.

The system may be implemented such that it includes a surface evaluator that provides a surface quality indication based on the image.

The system may be implemented such that the surface quality indication includes an orange peel indication, a defect residual indication, a haze indication or a scratch indication.

The system may be implemented such that the surface quality indication is a pass or fail indication based on a repair threshold.

The system may be implemented such that it includes a display component that displays the image.

The system may be implemented such that the display component is remote from the robotic arm. The controller communicates the image to the display component.

The system may be implemented such that it includes a storage component that stores the image.

The system may be implemented such that the surface is a curved surface.

The system may be implemented such that the curved surface includes curvature in two directions.

A method of evaluating a surface is presented that includes imaging the surface, using a line scan array imaging system, to produce an image of the surface. The imaging system moves along an imaging path with respect to the surface. The imaging path maintains a substantially constant distance between the line scan array imaging system and the surface. The method also includes processing the image to generate a processed image. The method also includes automatically generating an evaluation, using an image evaluate the image or processed image. The evaluation includes an indication of surface quality.

The method may be implemented such that the line scan array imaging system is in a haze imaging mode, and the processed image is a haze image.

The method may be implemented such that the haze imaging mode includes the imaging system in a dark field configuration.

The method may be implemented such that the processed image is a scratch image. The indication of surface quality is a scratch quantity, scratch severity, scratch depth, or scratch location.

The method may be implemented such that the scratch image is captured while the line scan imaging system is in a near-dark field configuration.

The method may be implemented such that the image or processed image is communicated to a display component which displays the image or processed image.

The method may be implemented such that the image or processed image is communicated to a storage component which stores the image or processed image in a retrievable form.

The method may be implemented such that the imaging system is mounted on a robotic arm. The imaging system is moved along the imaging path by the robotic arm.

The method may be implemented such that the imaging path is generated by a controller based on a topography of the curved surface.

The method may be implemented such that the topography is provided to the controller from a distance sensor array that detects the topography as the distance sensor array travels over the curved surface.

The method may be implemented such that the distance sensor array is mounted to the robotic arm, such that the distance sensor array travels ahead of the imaging system. The controller generates the imaging path in situ based on incoming sensor signals from the distance sensor array.

The method may be implemented such that the imaging path includes the robot arm changing a relative position of the imaging system with respect to the curved surface as the imaging path is executed.

The method may be implemented such that the imaging path includes the robot arm changing a relative orientation of the imaging system with respect to the robot arm as the imaging path is executed.

The method may be implemented such that changing the relative orientation of the imaging system with respect to the robot arm maintains a relative orientation of the imaging system with respect to the curved surface as the imaging path is executed.

The method may be implemented such that the distance sensor array is coupled to the imaging system.

The method may be implemented such that the distance sensor array is mounted to a second robot arm.

The method may be implemented such that the distance sensor array is mounted to the robot arm. In a first pass over the curved surface, the distance sensor array captures detects the topography and, in a second pass, the imaging system images the curved surface.

The method may be implemented such that the distance sensor array travels a topography path to detect the topography. The topography path is based on a retrieved 3D model of the curved surface.

The method may be implemented such that the imaging system includes a linescan array.

The method may be implemented such that the imaging system includes a 3D camera.

The method may be implemented such that the indication of surface quality includes an orange peel characterization, a defect residual indication, a scratch indication or a haze indication.

The method may be implemented such that the curved surface includes a repaired area. The indication of surface quality includes an indication of repair quality for the repaired area.

### EXAMPLES

### Example 1: Defect Repair Progression

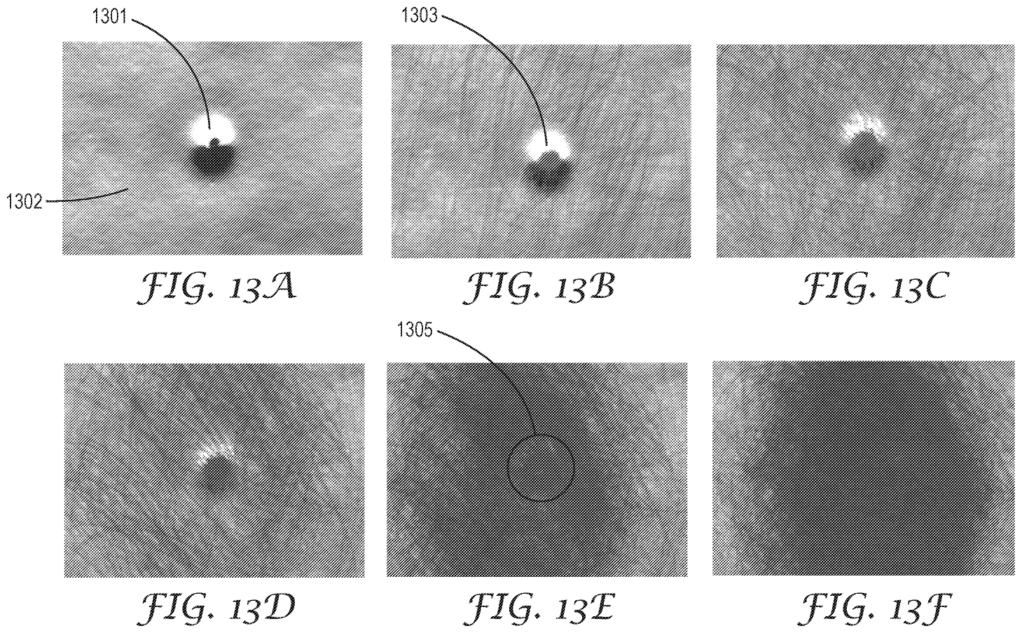

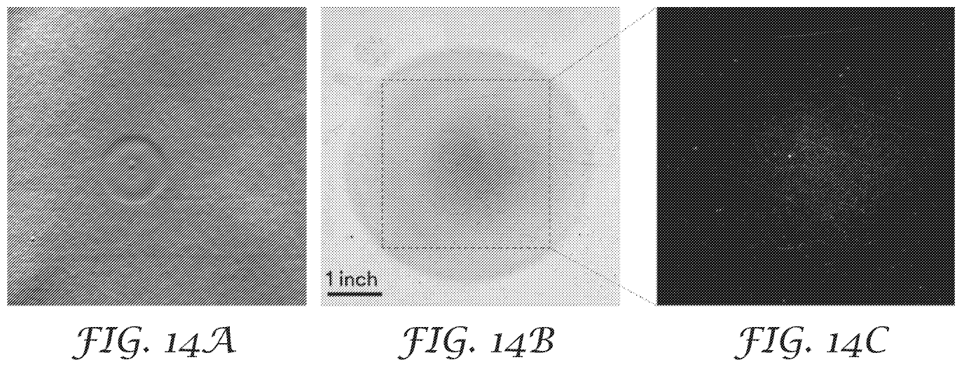

FIGS. 13A-F illustrate repair progression of a defect on a surface. FIG. 13A illustrates a defect with no repair completed. Defect 1301 is illustrated in the center with orange peel 1302 on the surface around the defect. FIG. 13B illustrates defect 1303 after some repair has been done, with scratches around the defect. Some of the peal has been removed. 13C-13F sequentially illustrate further defect repair, until the shape of the defect has been removed, in FIG. 13F. FIG. 13E illustrates a defect that has been almost completely removed but still has a visible defect residual. The residual is completely removed in FIG. 13F, which is preferred before polishing is conducted.

### Example 2: Defect Repair Images

FIGS. 14A-14C illustrate three image types that may be useful for revealing orange peel and defect residual. FIG. 14A illustrates a surface image with an incompletely removed defect, disturbed orange peel in the sanded area, and a crater left on the surface. FIG. 14B illustrates an image from the same area as FIG. 14A in a dark-field mode, followed by image processing, which reveals haze present after the buffing treatment, identified by the different contrast values which correlate with the severity of haze perceived by visual observation. FIG. 14C illustrates a darkfield image of the same area, which reveals buffing and random scratches as well as dust particles or other defects, which show up as white dots in the image.

### Example 4: Defect Repair Quantification

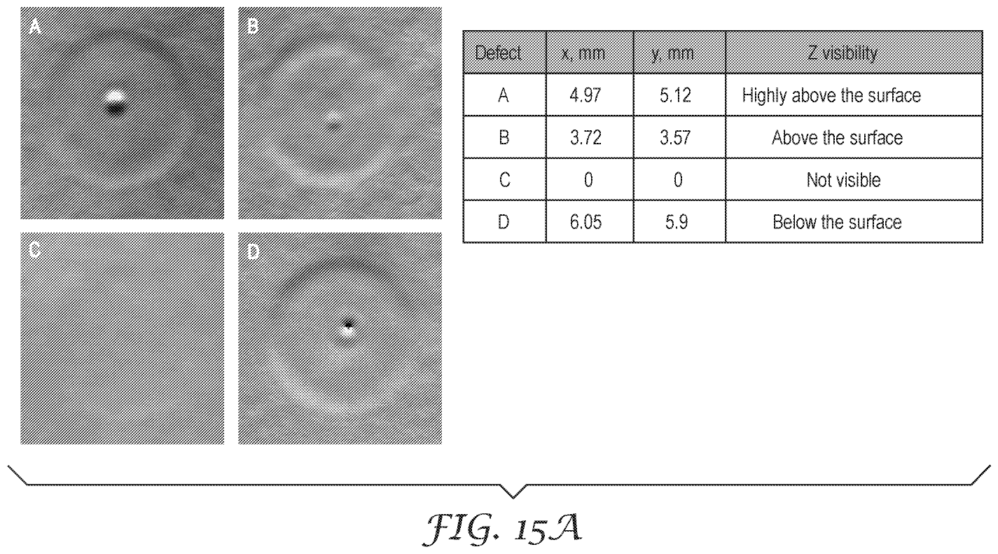

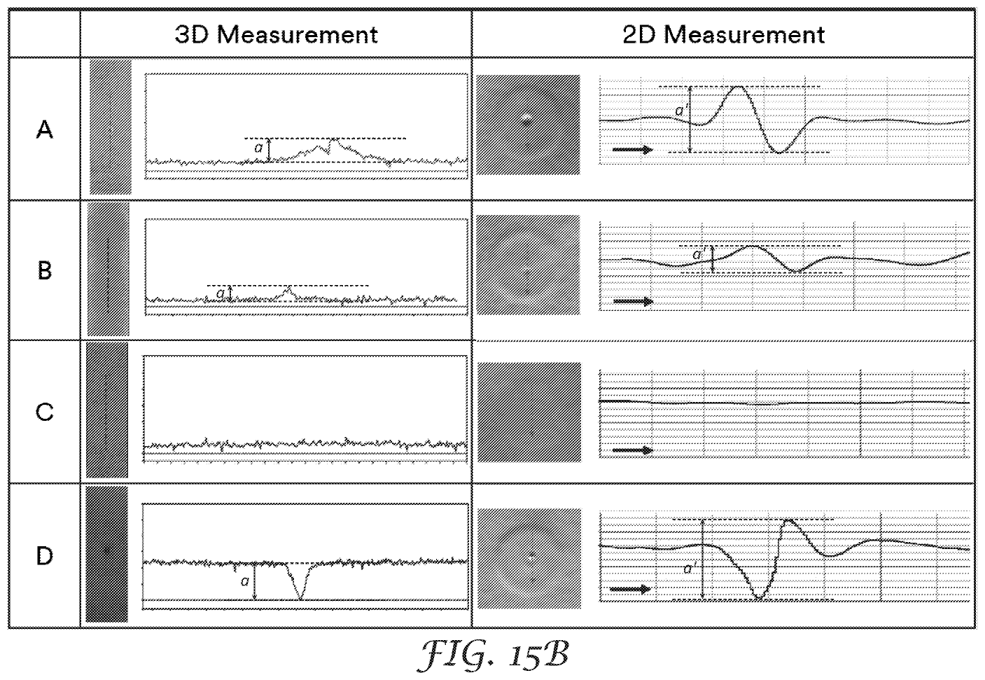

FIG. 15A illustrates images and quantification for four defect areas, taken post-repair. As illustrated, three of the defects (A, B, and D) all have visible defects, with a height characterization based on the captured images. Defect C was sufficiently removed to not be visible. As shown here, the size of the defects, in x and y directions, is measurable while the height of the defects (in z direction) can be only qualitatively evaluated. This might be useful during a post inspection process once the system only needs to decide the pass or failure of the repair. In addition, as shown in FIG. 15B, the light intensity profile taken from the defects (a′) is proportional to the height of the defects (a). In FIG. 15B, all defects shown in FIG. 15A have been characterized using a 3D non-contact laser profilometer to measure the defect's height. It shows that once the correlation between a and a′ is known (for example by a calibration procedure) the linescan array method may be used for defect's height estimation.

FIG. 15B illustrates further characterization of the defects.

1. A method of repairing a defect on a surface, the method comprising:
imaging the surface to locate the defect with a first imaging system;
conducting a repair operation by contacting the surface with an abrasive article, wherein the abrasive article is pressed into contact with the surface in an area of the defect by a robotic repair system;
imaging the abraded surface, with a second imaging system, wherein the second imaging system comprises a light source and wherein the imaging system operates in a near-dark field mode, with the light source and the linescan array in a first configuration with respect to the surface, and in a dark field mode, with the light source and the linescan array in a second configuration, wherein imaging comprises:
scanning the surface in the defect area to obtain a topography of the defect area;
passing the second imaging system over the defect area such that a distance between the second imaging system and the surface is maintained; and
generating an image of the defect area, wherein the image is a near dark field image or a dark field image; and
generating an evaluation regarding the repair operation based on the generated image.

2. The method of claim 1, wherein the second imaging system comprises a linescan array.

3. The method of claim 1, wherein the second imaging system comprises a light source.

4. The method of claim 1, wherein the image is a near dark field image, and wherein the method further comprises:
passing the second imaging system over the defect area in a second pass such that a second distance between the second imaging system and the surface is maintained; and
generating a dark field image of the defect area.

5. A surface evaluation system comprising:
an image capturing system that captures an image of a surface, wherein the image capturing system comprises:
a light source;
an image capturing device configured to capture a near dark field or dark field image of the surface; and
a movement mechanism configured to move the image capturing device with respect to the curved surface, wherein the movement mechanism maintains a fixed distance between the image capturing stance and the surface while the image capturing device moves with respect to the surface;
a view generator that, based on the near dark field or dark field image, generates a view of the surface.

6. The system of claim 5, wherein the generated view shows surface variations indicative of haze.

7. The system of claim 5, wherein the generated view shows surface variations indicative of discrete defects.

8. The system of claim 7, wherein the discrete defects are dents or similar surface variations; and further comprising a dent evaluator that provides a localized position of the dent and an indication of dent severity.

9. The system of claim 8, wherein the discrete defects are scratches; and further comprising a scratch evaluator that provides a localized position of the scratch and an indication of scratch severity.

10. The system of claim 5, and wherein, based on the image, a haze view or a scratch view, a surface evaluator provides a pass indication or a fail indication based on a comparison of the haze view or scratch view to a threshold, and wherein the pass indication is provided if the haze view or scratch view is outside an acceptable range.

11. The system of claim 5, and further comprising:
a path generator that receives topography information for the curved surface and, based on the topography information, generates a path for the movement mechanism that maintains a relative position of the image capturing device, the light source and the curved surface with respect to each other.

12. The system of claim 11, wherein the image capturing device, the surface and the light source form a right angle at a point on the surface being imaged.

13. The system of claim 11, wherein the topography information comprises a topography generated based on sensor information from a distance sensor array.

14. The system of claim 13, wherein the distance sensor array is coupled to the movement mechanism, and moves ahead of the image capturing device, with respect to the curved surface, and wherein the path generator generates the path and provides the path to the movement mechanism in situ.

15. The system of claim 5, wherein the image capturing device is a linescan array or a 3D camera.

16. The system of claim 5, and further comprising a lens between the image capturing device and the light source.

17. The system of claim 5, and further comprising a knife edge between the image capturing device and the light source.

18. The system of claim 5, wherein the surface is a curved surface and wherein maintaining the distance comprises adjusting a position of the imaging system to follow a curvature of the curved surface.

19. A robotic surface inspection system comprising:
a motive robotic arm;
an imaging system, coupled to the motive robotic arm, that captures an image of a surface, the imaging system comprising:
a light source;
a knife edge positioned in front of the light source;
an image capturing device positioned such that light from the light source passes in front of the knife edge, reflects off the surface to the image capturing device;
wherein a position of the light source and the image capturing device are fixed with respect to each other during an imaging operation; and
a movement mechanism that moves the imaging system with respect to a surface during the imaging operation so that a fixed distance and orientation is maintained between the surface and the imaging system is maintained;
a surface topography system comprising:
a distance sensor array that moves with respect to the surface; and
a topography generator that generates a topography based on sensor signals from the distance sensor array; and
a controller that generates movement commands to the motive robotic arm that maintains a relative position of the imaging system with respect to a surface being imaged as the imaging system and the surface are moved with respect to each other, and wherein the controller generates the movement commands based on the generated topography.

20. The system of claim 19, wherein the orientation comprises a right angle formed between the image capturing device, the surface, and the light source.

21. The system of claim 19, wherein, in a first movement sequence, the distance sensor array captures topography information and wherein, in a second movement sequence, the imaging system captures image information.

22. The system of claim 19, wherein the surface topography system and the imaging system are both active during a movement sequence, wherein the topography generator generates the topography in-situ, and wherein the controller generates the movement commands in-situ based on received topography information from the topography generator in substantially real-time.

23. The system of claim 19, wherein the surface is a curved surface.

24. The system of claim 23, wherein the curved surface comprises curvature in two directions.

25. A method of evaluating a surface, the method comprising:
imaging the surface, using a line scan array imaging system, to produce an image of the surface, wherein the imaging system moves along an imaging path with respect to the surface, and wherein the imaging path maintains a substantially constant distance between the line scan array imaging system and the surface;
processing the image to generate a processed image; and
automatically generating an evaluation, using an image evaluate the image or processed image, wherein the evaluation comprises an indication of surface quality.

26. The method of claim 25, wherein the line scan array imaging system is in a haze imaging mode, and the processed image is a haze image and wherein the haze imaging mode comprises the imaging system in a dark field configuration.

27. The method of claim 25, wherein the processed image is a scratch image, and wherein the indication of surface quality is a scratch quantity, scratch severity, scratch depth, or scratch location, and wherein the scratch image is captured while the line scan imaging system is in a near-dark field configuration.

28. The method of claim 25, wherein the imaging system is mounted on a robotic arm, and wherein the imaging system is moved along the imaging path by the robotic arm.

29. The method of claim 28, wherein the imaging path is generated by a controller based on a topography of the curved surface.

30. The method of claim 29, wherein the topography is provided to the controller from a distance sensor array that detects the topography as the distance sensor array travels over the curved surface.

31. The method of claim 30, wherein the distance sensor array is mounted to the robotic arm, such that the distance sensor array travels ahead of the imaging system, and wherein the controller generates the imaging path in situ based on incoming sensor signals from the distance sensor array.

32. The method of claim 31, wherein the imaging path comprises the robot arm changing a relative position or orientation of the imaging system with respect to the curved surface as the imaging path is executed.

33. The method of claim 32, wherein changing the relative orientation of the imaging system with respect to the robot arm maintains a relative orientation of the imaging system with respect to the curved surface as the imaging path is executed.

34. The method of claim 30, wherein the distance sensor array travels a topography path to detect the topography, and wherein the topography path is based on a retrieved 3D model of the curved surface.

35. The method of claim 25, wherein the imaging system comprises a linescan array.

36. The method of claim 25, wherein the imaging system comprises a 3D camera.

37. The method of claim 25, wherein the indication of surface quality comprises an orange peel characterization, a defect residual indication, a scratch indication or a haze indication.

38. The method of claim 25, wherein the curved surface comprises a repaired area, and wherein the indication of surface quality comprises an indication of repair quality for the repaired area.
